(19) United States
(12) Patent Application Publication
(10) Pub. No.: US 2025/0037226 A1
(43) Pub. Date: Jan. 30, 2025

(54) SAFE EVACUATION MANAGEMENT UTILIZING AUGMENTED REALITY

(71) Applicant: SAUDI ARABIAN OIL COMPANY, Dhahran (SA)

(72) Inventors: Mohannad M. SHAHRANI, Udhailiyah (SA); Tarek D. ABOGHONIEM, Udhailiyah (SA); Yahya A. ALI, Udhailiyah (SA)

(73) Assignee: SAUDI ARABIAN OIL COMPANY, Dhahran (SA)

(21) Appl. No.: 18/358,774

(22) Filed: Jul. 25, 2023

(51) Int. Cl. G06Q 90/00

(52) U.S. Cl. CPC G06Q 90/205

(57) ABSTRACT

A system for safe evacuation management of an industrial facility includes an analyzer operable to receive hazardous event indications and situational input. The analyzer can include a cloud engine operative to determine, from the hazardous event indications and the situational input, one or more of location, size, expansion rate, concentration, and motion direction and rate of a hazard at the industrial facility. The analyzer can also include a personnel tracking module operative to generate impacted personnel information from the hazardous event indications and the situational input, an evacuation route engine operative to receive the dynamic-state cloud representation, the impacted personnel information, and a plant model, and to generate therefrom an evacuation route representation, and a rendering engine operative to graphically represent an evacuation route customized for impacted personnel for delivery to user devices of impacted personnel.

### FIELD OF THE DISCLOSURE

The present disclosure relates generally to industrial facility safety, and more particularly, to guiding personnel to safety upon detection of a hazardous event at an industrial facility.

### BACKGROUND OF THE DISCLOSURE

Industrial facilities require continuous monitoring for any potential hazards that may impact the environment, personnel, and assets in order to ensure safety of operation. Also, facilities need to ensure safe and timely evacuation during any incident to ensure no impact on personnel who may be present.

Some types of hazards that may be encountered are gas leaks, whereby escaping material may be toxic or flammable or otherwise poses grave danger to human health, and avoidance through immediate evacuation is paramount. The leaking material may not be static, and may take the form of an expanding, traveling cloud of gas that must be tracked so that an evacuation route can be formulated and revised as necessary, and an up-to-date, animated rendering of the hazard as it expands or morphs and moves through the industrial facility can be rendered. Also, rescue and remediation measures depend on an accurate understanding of the real-time position and behavior of the hazard.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a system for safe evacuation management of an industrial facility includes an analyzer operable to receive hazardous event indications and situational input. The analyzer can include a cloud engine operative to determine, from the hazardous event indications and the situational input, one or more of location, size, expansion rate, concentration, and motion direction and rate of a hazard at the industrial facility. The analyzer can also include a personnel tracking module operative to generate impacted personnel information from the hazardous event indications and the situational input, an evacuation route engine operative to receive the dynamic-state cloud representation, the impacted personnel information, and a plant model, and to generate therefrom an evacuation route representation, and a rendering engine operative to graphically represent an evacuation route customized for impacted personnel for delivery to user devices of impacted personnel.

In another embodiment, a method includes collecting, using a processor, hazardous event indications and situational input of an industrial facility, determining, by the processor, from the hazardous event indications and the situational input, one or more of location, size, expansion rate, concentration, and motion direction and rate of a hazard at the industrial facility, generating, using the processor, impacted personnel information from hazardous event indications and situational input, receiving, by the processor, the dynamic-state cloud representation, the impacted personnel information, and a plant model, and generating therefrom an evacuation route representation, graphically representing, by the processor, an evacuation route customized for impacted personnel for delivery to user devices of impacted personnel.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of a system for safe evacuation management in accordance with certain embodiments.

FIG. 2 shows a displayed graphical representation that can be created by a rendering engine in accordance with certain embodiments

FIG. 3 is an example of a method for safe evacuation management in accordance with certain embodiments.

FIG. 4 is a block diagram of a computer system that may be used to implement one or more of the systems or methods described herein in accordance with certain embodiments.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to industrial facility safety, and more particularly, to guiding personnel to safety upon detection of a hazardous event at an industrial facility.

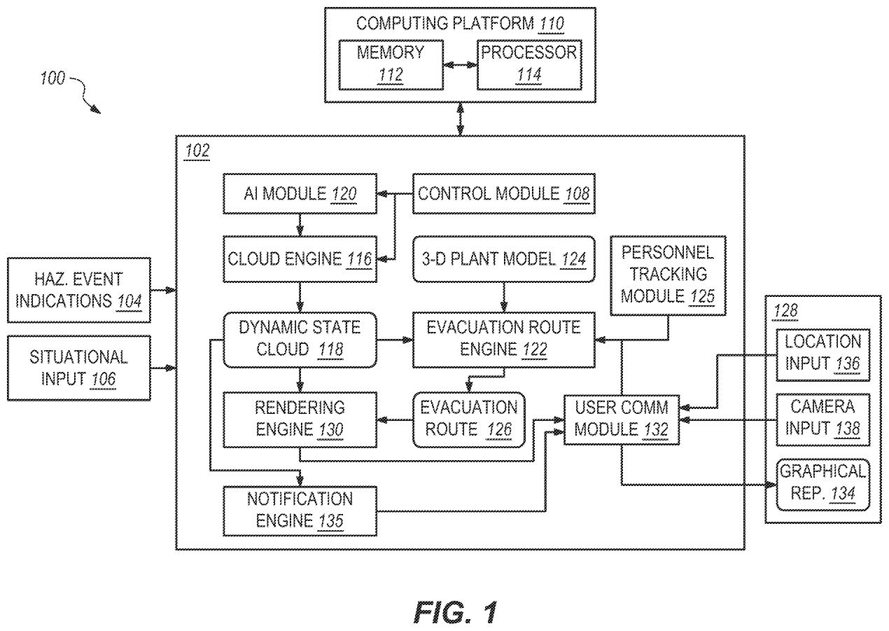

FIG. 1 is a block diagram of a system 100 for safe evacuation management in accordance with certain embodiments. System 100 includes an analyzer 102 that is configured for receipt of several types of inputs. One type of received input is hazardous event indications 104, which may be signals from gas, smoke or fire detectors, or detectors of other hazardous conditions, that have been triggered in the course of their operation to detect such phenomena. The detectors (not shown) may be distributed throughout an industrial facility and may be communicatively coupled to the analyzer 102 to provide an indication of the presence of hazardous conditions, such as gases of interest like hydrogen sulfide, carbon monoxide, and flammable gases including but not limited to methane, ethane, propane, and so on that may have inadvertently leaked out of equipment, or of smoke or fire, and that are posing a threat to safety. In certain embodiments, indications 104 may be regular reporting signals from gas, smoke or fire detectors, or detectors of other hazardous conditions. Thus in some instances the signals received from these detectors indicate normal conditions and absence of hazardous conditions, in which case they do not trigger action by analyzer 102. Only when they in fact indicate the presence of a hazardous condition is action by analyzer 102 triggered as further described herein.

Another type of input that analyzer 102 is configured to receive is situational input 106, relating to for example information about the current conditions and environment of the industrial facility, such as wind speed and direction, ambient temperature and humidity, and weather forecast. Situational input 104 can also include plant operational parameters, such as plant feed rate, as well as personnel headcount and distribution of personnel at the plant, and work permit type and location of the related job for the personnel. Work permit types may be based on job criticality and associated hazards, such as: cold work permit with no flammable hazards; hot work permit with flammable and toxic hazards; confined spaces entry work permit; and equipment opening line release work permit and location of the personnel.

Analyzer 102 includes a control module 108 operable to control operation of various components of the analyzer, for example upon notification of hazardous events hazardous event indications 104. One or more of these analyzer components, such as the control module 108, can be implemented (e.g., as machine readable instructions) on a computing platform 110. The computing platform 110 can include one or more computing devices selected from, for example, a desktop computer, a server, a controller, a blade, a mobile phone, a tablet, a laptop, a personal digital assistant (PDA), and the like. The computing platform 110 can include a memory 112 and a processor 114. By way of example, the memory 112 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 114 can be implemented, for example, as one or more processor cores.

The memory 112 can store machine-readable instructions that can be retrieved and executed by the processor 114. Each of the processor 114 and the memory 112 can be implemented on a similar or a different computing platform. The computing platform 110 can be implemented in a cloud computing environment (for example, as disclosed herein) and thus on a cloud infrastructure. In such a situation, features of the computing platform 110 can be representative of a single instance of hardware or multiple instances of hardware executing across the multiple of instances (e.g., distributed) of hardware (e.g., computers, routers, memory, processors, or a combination thereof). Alternatively, the computing platform 110 can be implemented on a single dedicated server or workstation.

Components of analyzer 102 can also include a cloud engine 116 operative to determine, from the hazardous event indications 104 and the situational input 106, location, size, expansion rate, concentration, and motion direction and rate of the hazard such as the leaked gas cloud. This can be determined from the type of gas involved and initial leak location and concentration, which is information that can be included in the hazardous event indications 104; as well as from the wind speed and direction, ambient temperature and humidity, weather forecast, and plant feed rate, which is information that can be included in the situational input 106. Cloud engine 116 uses this information to formulate a dynamic-state representation 118 of the hazardous gas cloud, and can apply an AI (artificial intelligence) algorithm of an AI module 120 which uses factors such as wind speed, wind direction, amount of released gases, ambient temperature, humidity, weather forecast, and other relevant inputs and historical data to accurately model the condition and motion of the dynamic-state representation 118 of the hazardous gas cloud. Thus the dynamic-state representation 118 is a prediction of cloud location, movement and size, and can include expansion rate, and movement rate and direction. It may also include cloud classification, such as poisonous, caustic, acidic, flammable, chlorine, phosgene, sulphur, smoke, and can identify the type of gas or hazard as well as concentration and other information.

Components of analyzer 102 also include an evacuation route engine 122 configured receive the dynamic-state cloud representation 118 as well as a 3-D plant model 124, and to generate therefrom an evacuation route representation 126 that can most efficiently direct personnel towards safety. The evacuation route takes into account personnel headcount and personnel distribution and location at the plant, and work permit type and location of the related job, from the situational input 106, so that personnel can be best accounted for and most efficiently ushered to safety. This personnel information can be tracked by personnel tracking module 125, which thus determines impacted personnel and allows analyzer 102 to use impacted personnel information to customize and push evacuation routes and notifications to the impacted personnel as detailed below.

In certain embodiments, the determined evacuation route can be graphically displayed on a user device 128 such as a smart phone, laptop, tablet or the like. A rendering engine 130 receives the evacuation route representation 126 and uses it, along with the 3-D plant model 124, to graphically represent an evacuation route juxtaposed over a 3-D image of the industrial facility. A user communication module 132 is used to deliver the graphical representation output 134 from the rendering engine 130 to the user devices.

In certain embodiments, a notification engine 135 is provided to directly notify users who may be affected by the hazardous condition, such as the moving cloud heading in their direction, as a function of their location in the industrial facility and the likelihood of the hazard reaching them. Notification engine outputs notifications to affected users, and potentially other stakeholders, by way of user communication module 132.

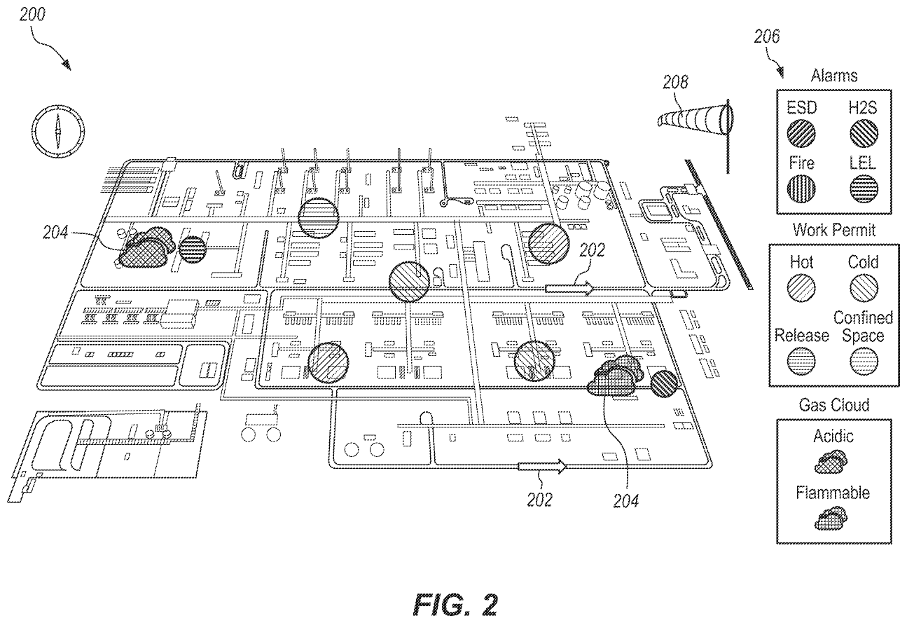

FIG. 2 shows a displayed graphical representation 200 corresponding to the graphical representation 134 that can be created by rendering engine 130. The displayed graphical representation 200 can include the industrial facility and evacuation route, indicated by arrows 202 showing the direction of egress to safety. It can also include the hazards, potentially in real-time, animated form for example corresponding to an expanding and traveling cloud 204 as computed by cloud engine 116 (FIG. 1). The displayed graphical representation 200 can also include a legend 206 that indicates the Alarms, which are ESD, H2S, Fire, and LEL; Work Permit Hot, Cold, Release, and Confined Space; and Gas Cloud Acidic and Flammable indicating, respectively, an acidic gas cloud and a flammable gas cloud. A wind sock 208 shows wind direction.

In certain embodiments, system 100 (FIG. 1) can include location input 136, specific to each user or user device 128 (i.e., smart phone, laptop, tablet, etc.) so that the evacuation route representation can be customized to that user for best guiding that particular user to safety. The location input 136 can be provided by the user device in accordance with known location services that such devices conventionally possess. In certain embodiments, camera input 138 can be provided, allowing the evacuation route engine 122 to construct an augmented reality (AR) view depicting the evacuation route by for example juxtaposing virtual beacons or arrows in the image view captured by a camera of the user device (i.e., smart phone, laptop, tablet, etc.) and displayed in a display of the user device 128 to help guide the user to safety.

In certain embodiments, in lieu of or in addition to presentation on the user device, the determined evacuation route 126 can be visually and/or aurally indicated, for example by coded lighting, such as a trail of green LED beacons at various locations in the industrial facility forming a path for the evacuee to follow, or pre-recorded voice messages (e.g. “Evacuation route this way!”), that personnel are trained to follow to safety.

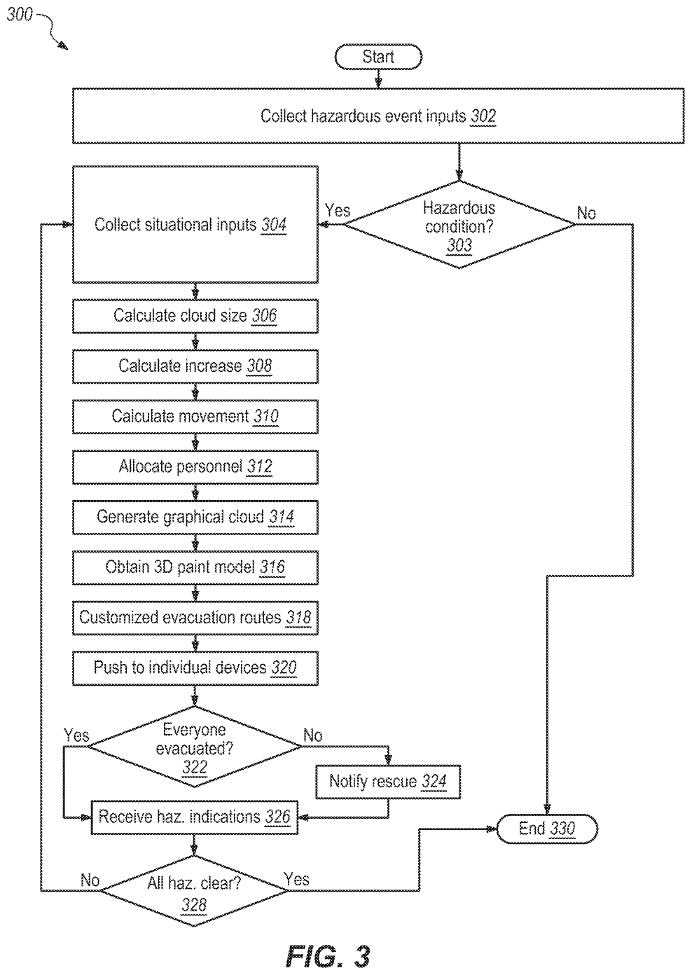

In view of the structural and functional features described above, example an method will be better appreciated with reference to FIG. 3. While, for purposes of simplicity of explanation, the example method of FIG. 3 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the method, and conversely, some actions may be performed that are omitted from the description.

FIG. 3 is an example of a method 300 for safe evacuation management in accordance with certain embodiments. The method 300 can be implemented by analyzer 102 as shown in FIG. 1. At 302, hazardous event indications 104 are collected. At 303, a determination is made, for example by control module 108, whether a hazardous condition exists, and if not, the process ends. If a hazardous event is indicted, situational inputs 106 are collected. At 306, 308 and 310, cloud size, cloud size increase, and cloud movement are respectively calculated by cloud engine 116 in conjunction with AI module 120. At 312, an allocation of personnel is performed, whereby the personnel of the industrial facility are accounted for such as by personnel tracking module 125. At 314, a dynamic state cloud 118 is generated. At 316, a 3-D plant model is obtained. At 318, customized evacuation routes 126 are created, for example by evacuation route engine 122. At 320, the evacuation routes are pushed and rendered no individual user devices 128, for example by way of user communication module 132. At 322 a determination is made whether all personnel have been evacuated. This can be performed by control module 108, based on location input 136 from the user devices 128. If not all personal are evacuated, at a predetermined time, at 324, rescue teams can be notified, for example by communication with a rescue device comparable to user device 128 and in a similar manner, or through a dedicated rescue channel (not shown). At 326, hazardous event indications 104 continue to be received until, at 328, a determination is made whether all hazards are clear. If so, then the method 300 ends at 330; otherwise it returns to 304 to collect situational inputs 106 and repeat.

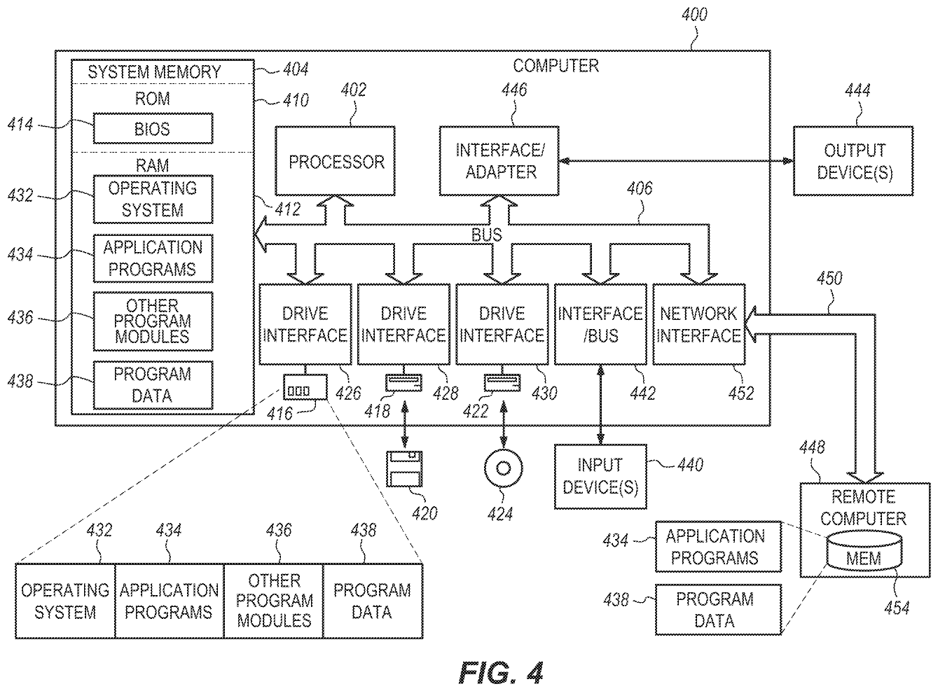

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 4. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 4 illustrates one example of a computer system 400 that can be employed to execute one or more embodiments of the present disclosure. Computer system 400 can be implemented on one or more general purpose networked computer systems, embedded computer systems, routers, switches, server devices, client devices, various intermediate devices/nodes or standalone computer systems. Additionally, computer system 400 can be implemented on various mobile clients such as, for example, a personal digital assistant (PDA), laptop computer, pager, and the like, provided it includes sufficient processing capabilities.

Computer system 400 includes processing unit 402, system memory 404, and system bus 406 that couples various system components, including the system memory 404, to processing unit 402. System memory 404 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 402. System bus 406 may be any of several types of bus structure including a memory bus or memory controller, a peripheral bus, and a local bus using any of a variety of bus architectures. System memory 404 includes read only memory (ROM) 410 and random access memory (RAM) 412. A basic input/output system (BIOS) 414 can reside in ROM 410 containing the basic routines that help to transfer information among elements within computer system 400.

Computer system 400 can include a hard disk drive 416, magnetic disk drive 418. e.g., to read from or write to removable disk 420, and an optical disk drive 422, e.g., for reading CD-ROM disk 424 or to read from or write to other optical media. Hard disk drive 416, magnetic disk drive 418, and optical disk drive 422 are connected to system bus 406 by a hard disk drive interface 426, a magnetic disk drive interface 428, and an optical drive interface 430, respectively. The drives and associated computer-readable media provide nonvolatile storage of data, data structures, and computer-executable instructions for computer system 400. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 410, including operating system 432, one or more application programs 434, other program modules 436, and program data 438. In some examples, the application programs 434 can include analyzer 102 and/or one or more of its components, and the program data 438 can include, dynamic state cloud 118, 3-D plant model 124, evacuation route 126, and graphical representation 134. The application programs 434 and program data 438 can include functions and methods programmed to conduct safe evacuation management, such as shown and described herein.

A user may enter commands and information into computer system 400 through one or more input devices 440, such as a pointing device (e.g., a mouse, touch screen), keyboard, microphone, joystick, game pad, scanner, and the like. For instance, the user can employ input device 440 to edit or modify situational input 106. These and other input devices 440 are often connected to processing unit 402 through a corresponding port interface 442 that is coupled to the system bus, but may be connected by other interfaces, such as a parallel port, serial port, or universal serial bus (USB). One or more output devices 444 (e.g., display, a monitor, printer, projector, or other type of displaying device) is also connected to system bus 406 via interface 446, such as a video adapter.

Computer system 400 may operate in a networked environment using logical connections to one or more remote computers, such as remote computer 448. Remote computer 448 may be a workstation, computer system, router, peer device, or other common network node, and typically includes many or all the elements described relative to computer system 400. The logical connections, schematically indicated at 450, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 400 can be connected to the local network through a network interface or adapter 452. When used in a WAN networking environment, computer system 400 can include a modem, or can be connected to a communications server on the LAN. The modem, which may be internal or external, can be connected to system bus 406 via an appropriate port interface. In a networked environment, application programs 434 or program data 438 depicted relative to computer system 400, or portions thereof, may be stored in a remote memory storage device 454.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A system for safe evacuation management of an industrial facility, the system comprising:
an analyzer operable to receive hazardous event indications and situational input, the analyzer including:
a cloud engine operative to determine, from the hazardous event indications and the situational input, one or more of location, size, expansion rate, concentration, and motion direction and rate of a hazard at the industrial facility;
a personnel tracking module operative to generate impacted personnel information from the hazardous event indications and the situational input;
an evacuation route engine operative to receive the dynamic-state cloud representation, the impacted personnel information, and a plant model, and to generate therefrom an evacuation route representation; and
a rendering engine operative to graphically represent an evacuation route customized for impacted personnel for delivery to user devices of impacted personnel.

2. The system of claim 1, wherein the hazard is a cloud of gas.

3. The system of claim 2, further comprising an AI (artificial intelligence) module operable to apply an AI algorithm to accurately model the condition and motion of the cloud of gas.

4. The system of claim 1, wherein the analyzer is configured to receive location input from the user devices.

5. The system of claim 1, wherein the analyzer is configured to receive camera input from the user devices.

6. The system of claim 1, wherein the analyzer includes a notification engine to directly notify users of the user devices.

7. The system of claim 1, wherein the rendering engine further graphically represents the hazard in animated form.

8. A method comprising:
collecting, using a processor, hazardous event indications and situational input of an industrial facility;
determining, by the processor, from the hazardous event indications and the situational input, one or more of location, size, expansion rate, concentration, and motion direction and rate of a hazard at the industrial facility;
generating, using the processor, impacted personnel information from hazardous event indications and situational input;
receiving, by the processor, the dynamic-state cloud representation, the impacted personnel information, and a plant model, and generating therefrom an evacuation route representation; and
graphically representing, by the processor, an evacuation route customized for impacted personnel for delivery to user devices of impacted personnel.

9. The method of claim 8, wherein the hazard is a cloud of gas.

10. The method of claim 9, further comprising applying an AI (artificial intelligence) algorithm to accurately model the condition and motion of the cloud of gas.

11. The method of claim 8, further comprising receiving location input from the user devices.

12. The method of claim 8, further comprising receiving camera input from the user devices.

13. The method of claim 8, further comprising directly notifying users of the user devices.

14. The method of claim 8, further comprising graphically representing the hazard in animated form.

15. The method of claim 8, further comprising providing an augmented reality of view of an evacuation route on the user devices.
